(19) United States
(12) Patent Application Publication
(10) Pub. No.: US 2019/0153372 A1
(43) Pub. Date: May 23, 2019

(54) LIQUID REFINEMENT APPARATUS AND METHODS OF USE

(71) Applicant: Christopher O. NORMAN, Olathe, KS (US)

(72) Inventor: Christopher O. NORMAN, Olathe, KS (US)

(21) Appl. No.: 16/196,982

(22) Filed: Nov. 20, 2018

Related U.S. Application Data
(60) Provisional application No. 62/588,770, filed on Nov. 20, 2017.

(51) Int. Cl. C12G 3/07

(52) U.S. Cl. CPC C12G 3/065; C12C 5/026

(57) ABSTRACT

An apparatus and method configured to macerate a liquid. The apparatus comprises a liquid reservoir; a collector; and a maceration pod configured for hydraulic communication with the reservoir and the collector, the maceration pod comprising a plurality of toasted wooden particles. The plurality of toasted wooden particles comprising: a particle size between about 200 microns and 1180 microns; a volume between 5 teaspoons to 8 teaspoons; and a volumetric ratio of medium toasted wood particles to heavy toasted wood particles of between about 1:1 and about 5:1. Methods of macerating a fluid at atmospheric pressure and above.

### CROSS-REFERENCE TO RELATED APPLICATIONS

This present non-provisional patent application claims priority of an earlier-filed provisional patent application titled LIQUID REFINEMENT APPARATUS AND METHODS OF USE, Ser. No. 62/588,770, filed Nov. 20, 2017. The contents of the identified earlier-field application are hereby incorporated into the present non-provisional patent application in their entirety.

### TECHNICAL FIELD

This invention relates generally to a liquid refinement apparatus and more particularly, but not necessarily exclusively, to an apparatus for maceration of alcoholic spirits.

### BACKGROUND

For centuries, distillers have aged alcoholic spirits in wooden barrels between the distillation and bottling processes in order to enhance the flavor profile of the finished product. The process of charring, also known as toasting, the inside of the barrels prior to the aging process has been employed by distillers to produce a desired flavor profile of the aged spirit through the release of oils and flavors of the charred wood into the aging spirit. Depending on the size of the barrel and the desired flavor profile, spirits are typically barrel aged between one month up to twenty years, and beyond. This barrel-aging process requires extensive labor, environmental controls, and warehousing space in order to produce a consistent flavor profile. Some distillers add wooden chips to the barrels during the aging process in an attempt to expedite the time required to achieve a desired flavor profile with limited success. It is desirable to produce a spirit with a desired barrel-aged flavor profile without the time, labor, and expense required by the traditional barrel-aging process.

### SUMMARY

The disclosed subject matter is directed towards a liquid refinement apparatus that rapidly changes the flavor profile of a liquid through a dynamic maceration process. A liquid refinement apparatus having features of the present invention comprises: a liquid reservoir; a maceration pod configured to hydraulically communicate with the reservoir; and a collector adjacent to the maceration pod. In another embodiment, the maceration pod comprises particles, preferably wooden particles comprising alone, or in combination, medium toasted wood particles or heavy toasted wood particles. In another embodiment the maceration pod is connected between the liquid reservoir and the collector; whereby the liquid reservoir and collector are in hydraulic commination with each other. In another embodiment, the apparatus comprises an extension portion connected between the reservoir and collector, the extension portion configured to secure a plurality of maceration pods therein. In yet another embodiment, the liquid comprises an alcohol for human consumption such as distilled spirits.

In another embodiment, the maceration pod comprises: a first layer having a peripheral edge; a second layer connected to the first layer along the peripheral edge, wherein a cavity is formed between the first layer and the second layer; and particles disposed within the cavity. In another embodiment, the peripheral edge is attached between the outlet and the collector, whereby the liquid reservoir and collector are in hydraulic commination with each other.

In some embodiments, the wooden particles comprise, alone or in combination, wood varieties such as oak, maple, hickory, cherry, birch, or apple.

In another embodiment, the collector is supported by a support structure configured to stabilize the collector to provide collection of a refined liquid via gravity into a receiver generally positioned below the collector. The support structure comprises a generally horizontal platform supported by vertical support members. In some embodiments, the platform comprises a hole disposed through the platform to secure the collector in a vertical position.

In another embodiment, the wooden particles comprise a particle size up to about 1180 microns. In another embodiment, the wooden particles comprise a particle size of at least 200 microns. In another embodiment, the wooden particles range in particle size between 200 microns and 1180 microns. In yet another embodiment, about 50% of the wooden particles comprise a particle size of at least about 600 microns.

In some embodiments, the volume of particles comprise at least about 5 teaspoons and no more than about 8 teaspoons. In some embodiments, the volume of particles comprise about 5 teaspoons medium toasted wooden particles and about 1.5 teaspoons heavy toasted wooden particles.

In another embodiment, the wooden particles comprise at least 30 percent a particle size of at least about 600 microns. In another embodiment, the wooden particles comprise up to 70 percent a particle size of at least about 600 microns. In another embodiment, the wooden particles comprise from 30 percent to 70 percent a particle size of at least about 600 microns.

In another embodiment, the volumetric ratio of medium toasted wooden particles to heavy toasted wooden particles comprises at least 1:1 and no more than about 5:1. In another embodiment, the volumetric ratio of medium toasted wooden particles to heavy toasted wooden particles comprises about 3.3:1.

In some embodiments of the disclosed subject matter, a dosed liquid in the reservoir may be exposed to an atmospheric pressure whereby the dosed liquid is passed through the maceration pod by means of gravity. In other configurations of the disclosed subject matter, the dosed liquid in the reservoir may be pressurized above the atmospheric pressure and the dosed liquid is driven through the maceration pod at an elevated pressure.

In some embodiments of the disclosed subject matter, the liquid refinement apparatus comprises: a reservoir comprising an inlet, an inside wall, and an outlet; and a maceration pod housing wooden particles, the maceration pod fitted to the inside wall; wherein the inlet and outlet are in fluid communication. In some embodiments, the inside wall is dimensioned to slope downwardly from the inlet and the outlet. In some embodiments, the reservoir further comprises a bottom section configured to slope downwardly towards the outlet. In yet another embodiment, the outlet comprises perforated bottom section. In some configurations, the maceration pod is configured to deform to the inside wall of the reservoir. The reservoir may be configured in the general shape of a funnel.

Some additional configurations of the disclosed subject matter provide methods of dynamically macerating of a liquid through a maceration pod. An embodiment of the method includes providing a liquid refinement apparatus comprising: a liquid reservoir having an inlet; a maceration pod configured to hydraulically communicate with the reservoir, the maceration pod comprising a plurality of toasted wooden particles therein; and a collector adjacent to the outlet; dosing a liquid into the inlet; macerating the liquid through the maceration pod; and collecting the refined liquid in the collector. The method may include the step of pressurizing the liquid prior to the maceration step.

Another embodiment of the method includes providing a reservoir comprising an inlet, an interior surface, and an outlet; inserting a maceration pod into the reservoir; the maceration pod configured to snuggly fit to the interior surface; pouring a liquid into the inlet; macerating the liquid through maceration pod; and collecting the refined liquid from the outlet. In other embodiment, the maceration pod is pressed into the reservoir, thereby deforming the maceration pod onto the interior surface.

Another embodiment of the method includes disposing a maceration pod between a first section and a second section; providing a pressurized liquid to the first section; macerating the liquid through the maceration pod; and passing the refined liquid through the second section.

Another embodiment of the method includes disposing a maceration pod between a first section and a second section; pressurizing the first section; macerating the liquid through the maceration pod; and passing the refined liquid through the second section.

### BRIEF DESCRIPTION OF THE DRAWINGS

The present disclosed subject matter is described herein with reference to the following drawing figures, with greater emphasis place on clarity rather than scale:

FIG. 1 is a schematic view of an embodiment of the disclosed subject matter.

FIG. 2 is a schematic view of an embodiment of the disclosed subject matter.

FIG. 3A is a schematic view of an embodiment of the disclosed subject matter.

FIG. 3B is a sectional view of an embodiment of the disclosed subject matter.

FIG. 4 is a sectional view of an embodiment of the disclosed subject matter.

FIG. 5 is a sectional view of an embodiment of the disclosed subject matter.

FIG. 6 is a sectional view of an embodiment of the disclosed subject matter.

FIG. 7 is a sectional view of an embodiment of the disclosed subject matter.

FIG. 8 is a sectional view of an embodiment of the disclosed subject matter.

FIG. 9 is a flow chart of a method of use of an embodiment of the disclosed subject matter.

FIG. 10 is a flow chart of a method of use of an embodiment of the disclosed subject matter.

FIG. 11 is a flow chart of a method of use of an embodiment of the disclosed subject matter.

FIG. 12 is a flow chart of a method of use of an embodiment of the disclosed subject matter.

FIG. 13, is a sectional view of an embodiment of the disclosed subject matter.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Although the disclosed subject matter has been disclosed with reference to various particular embodiments, it is understood that equivalents may be employed and substitutions made herein without departing from the scope of the disclosed subject matter as recited in the claims.

Certain terminology will be used in the following description, and are shown in the drawings, and will not be limiting. For example, up, down, front, back, right and left refer to the disclosed subject matter as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The detailed description includes the disclosure of numerical ranges. Numerical ranges should be construed to provide literal support for claim limitations reciting only the upper value of a numerical range, and provide literal support for claim limitations reciting only the lower value of a numerical range.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

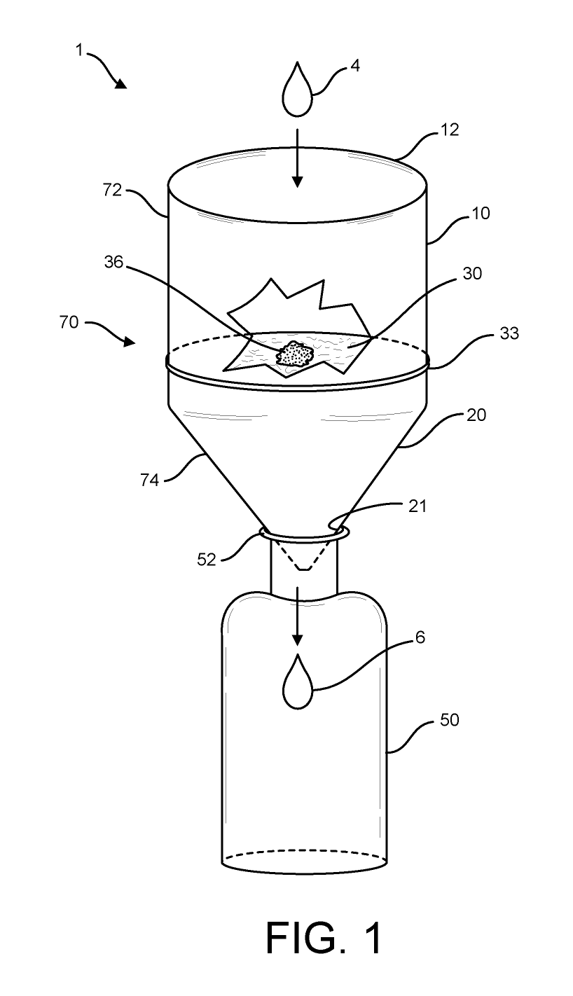

Referring to FIG. 1, the liquid refinement apparatus 1 comprises a liquid reservoir 10, a maceration pod 30 configured to hydraulically communicate with the reservoir 10, and a collector 20 adjacent to the maceration pod 30. A dosed liquid 4 may comprise, for example, an alcohol for human consumption including distilled spirits, wine, beer, cider, mead, or pulque. The dosed liquid 4 placed into to the reservoir 10 flows downward by gravity through the reservoir 10 and into the maceration pod 30 for refinement. The dosed liquid 4 then passes through the maceration pod 30 for maceration with the particles 36 disposed within the maceration pod 30. The collector 20 is configured to collect and route the refined liquid 6 from the bottom of the maceration pod 30 into a receiver 50 generally positioned below the collector 20.

The reservoir 10 is sized to hold the entire volume of dosed liquid 4. The volume of the reservoir 10 is at least about 4 oz., and preferably at least about 6 oz.

In some embodiments, the reservoir 10 may include a wide-mouth inlet 12 in order to assist in the transfer of the dosed liquid 4 into the reservoir 10 and to provide easy access to the interior of the reservoir 10 for cleaning. In other embodiments (not shown), the reservoir 10 includes an inlet 12 having an opening less than the width of the reservoir. The inlet 12 to the reservoir 10 may be sealable in order to keep foreign contaminants out of the reservoir 10.

The collector 20 is configured to collect and route the refined liquid 6 into the receiver 50. In some embodiments, the collector 20 may be configured in the shape of a funnel (as shown in FIG. 1), pan, channel, hose, pipe or tube. The collector 20 may be connected to the bottom of the reservoir 10, or the collector 20 may be positioned below the reservoir to allow for the collection of the refined liquid 6.

In some embodiments, the reservoir 10 and the collector 20, together, may comprise a two-piece funnel 70, wherein the maceration pod 30 is disposed between an upper portion 72 and a lower portion 74 of the two-piece funnel. The two-piece funnel 70 may include a generally cylindrical cross section having a wide mouth opening to allow for the dosed liquid 4 to be easily poured into the funnel 70. The upper portion 72 and the lower portion 74 of the funnel 70 may be coupled together by pressure fittings, screws, bolts, clamps, couplings, or other suitable mechanical means.

The maceration pod 30 may be attached between the reservoir 10 and the collector 20 generally along a peripheral edge 33 of maceration pod 30. In other configurations, the maceration pod 30 is configured to snuggly fit to an interior surface of the reservoir 10 or collector 20; whereby the maceration pod 30 is secured to the interior surface if the reservoir 10 is turned upside down. The snug fit of the maceration pod 30 to the interior surface of the reservoir 10 safeguards that the dosed liquid 4 does not bypass around the peripheral edge 33 of the maceration pod 30.

The receiver 50 is sized and configured to hold the refined liquid 6. The receiver 50 may be configured in the shape of a bottle, flask, cup, jar, or other water impermeable container. The receiver 50 provides a means to exhaust air out of the receiver 50 in order to prevent air lock between the collector 20 and the receiver 50 while the refined liquid 6 is being passed through the collector 20 into the receiver 50. A means to exhaust air may comprise a first air gap 21 formed between the collector 20 and the receiver 50. The means to exhaust air may alternatively comprise a vent hole or air release valve (neither shown in FIG. 1) disposed near an opening 52 of the receiver 50.

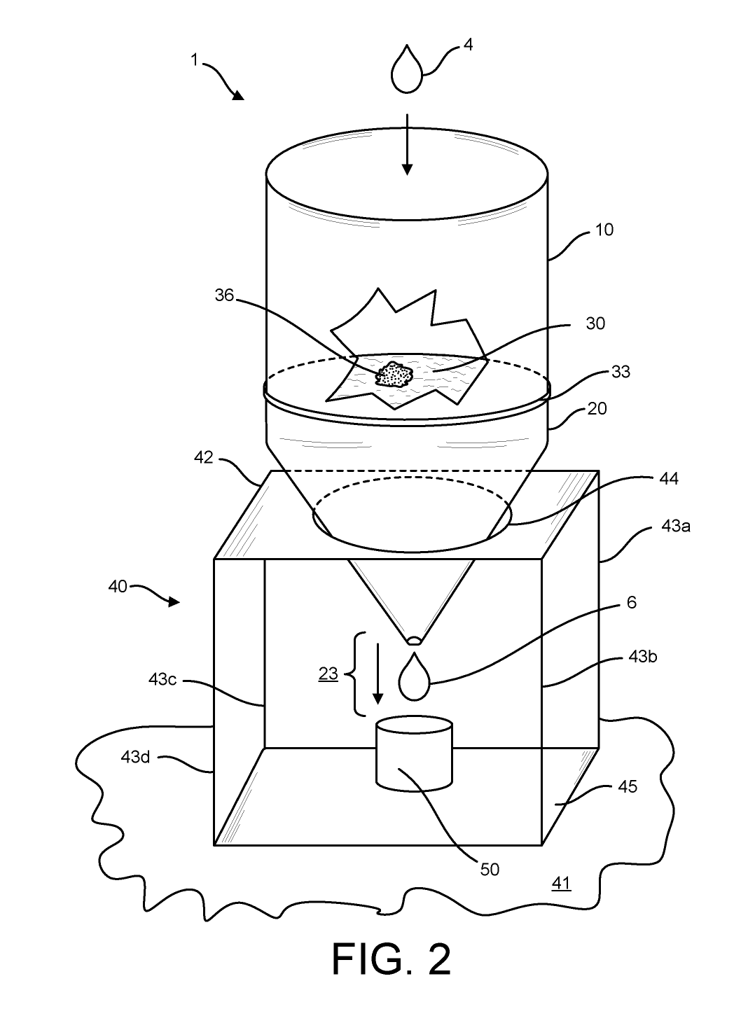

Referring to FIG. 2, in some embodiments, the liquid refinement apparatus 1 is physically supported by a support structure 40 configured to elevate the collector 20 above a working surface 4. The support structure 40 is additionally configured to stabilize the collector 20 during operation and storage. In some embodiments, the support structure 40 comprises a generally horizontal platform 42 supported by plurality of vertical support members 43a-d. The support structure 40 may further comprise a base member 45 connected to the plurality of vertical support members 43a-d. The platform 42 having a hole 44 configured to receive the collector 20 and hold the collector 20 in a generally vertical position. A second air gap 23, located between the collector 20 and receiver 50, allows for the free flow of refined liquid 6 by gravity through collector 20. The use of the support structure 40 is desirable for operation of the liquid refinement apparatus 1 without additional human support. Additionally, the support structure 40 may be utilized to store and display the liquid refinement apparatus 1 when not in use.

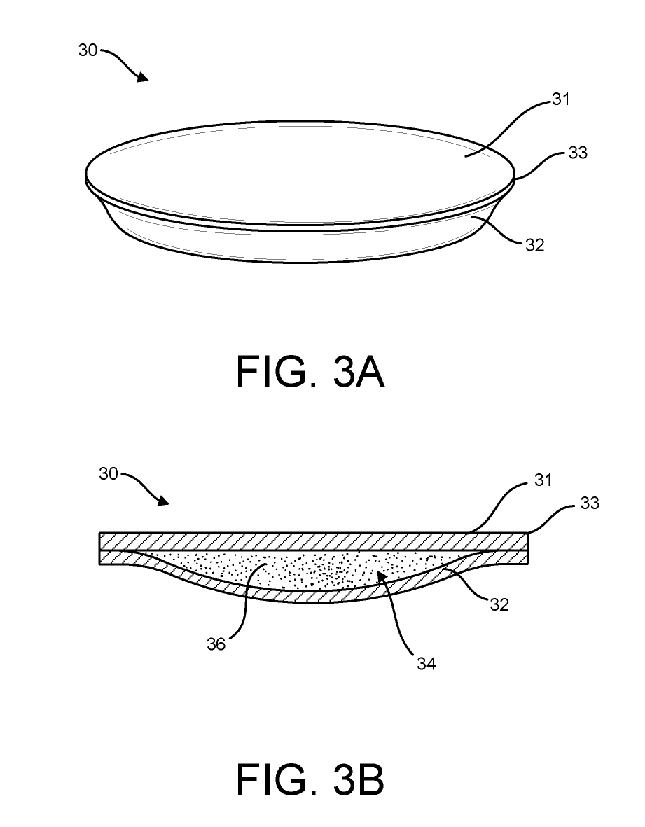

Referring to FIG. 3A and FIG. 3B, in some embodiments of the disclosed subject matter, the maceration pod 30 may include a first layer 31 having a peripheral edge 33; a second layer 32 attached to the first layer 31 along the peripheral edge 33, wherein a cavity 34 is formed between the first layer 31 and second layer 32; and particles 36 disposed within the cavity 34.

The first layer 31 is generally planar and circular in shape, but may be configured as other shapes in order to hydraulically communicate with the reservoir 10 without bypass of the liquid around the maceration pod 30. The first and second layers 31,32 may each comprise of a liquid-permeable membrane including food grade filter paper such as commonly used for coffee filters or tea filters. It is desirable for the first and second layers 31,32 to be thin and flexible in order for the peripheral edge 33 to freely deform between the reservoir 10 and collector 20. The first and second layers 31,32 may be connected by means of heat sealing methods, adhesives, and/or stitching, so the first and second layers 31,32 do not separate when saturated by the dosed liquid 4. A pore size of the first and second layers 31,32 is preferably no more than about 100 microns to avoid wash out of the particles 36 when the dosed liquid 4 is passed through the maceration pod 30.

In some embodiments, the particles 36 may comprise, for example, alone or in combination, wood varieties including oak, maple, hickory, cherry, birch, or apple. In order to increase a surface area of the particles 36 in contact with the dosed liquid 4, and decrease a contact time of the dosed liquid 4 with the particles 36, the particle size of the particles 36 is typically no more than about 1180 microns. In some embodiments of the disclosed subject matter, the particle size distribution of the particles 36 may range according to Table 1 below.

TABLE 1
Particle Size Distribution

| Volume of Particles (%) | Particle Size (microns) | | |
|---|---|---|---|
| 30-70 | <600 | <625 | 200-600 |
| 30-70 | >600 | >800 | 850-1180 |
| 40-60 | <600 | <625 | 200-600 |
| 40-60 | >600 | >800 | 850-1180 |
| 45-55 | <600 | <625 | 200-600 |
| 45-55 | >600 | >800 | 850-1180 |
| 50 | <600 | <625 | 200-600 |
| 50 | >600 | >800 | 850-1180 |

For example, and referring to Table 1, in an embodiment of the disclosed subject matter, about 30-70% of the volume of particles 36 comprise a particle size less than about 600 microns, while a remaining volume of particles 36 comprise a particle size greater than about 600 microns. In another example according to Table 1, about 50% of the volume of particles 36 comprise a particle size less than about 600 microns, while the remaining volume of particles 36 comprise a particle size greater than about 600 microns.

Providing more than about 70% of particles 36 less than about 600 microns results in an extended contact time whereby the refined liquid 6 is dark and strong. Using more than about 70% of particles 36 greater than about 600 microns results in a refined liquid 6 that is light in color and weakly flavored.

A flavor profile of the dosed liquid 4 and refined liquid 6 includes flavors and aromas such as woody, vanilla, nutty, buttery, and/or smoky; along with taste characteristics such as sweetness and smoothness.

The particles 36 may comprise, for example, alone or in combination, wood particles previously exposed to various levels of heat, a process known as toasting or charring. Generally, the relative level of toasting or charring (light, medium, and heavy) influences the sweetness, smoothness and mellowness of the flavor profile of the refined liquid 6. For example, a dosed liquid 4 dynamically macerated with heavy toasted wooden particles results in a refined liquid 6 with sweeter, smoother and/or mellower characteristics than if the dosed liquid 4 was dynamically macerated with light toasted wooden particles.

In order to obtain a desired flavor profile of the refined liquid 6, the volumetric ratio of medium toasted wooden particles to heavy toasted wooden particles is typically at least 1:1 and no more than about 5:1; preferably at least about 2:1 and no more than about 4:1; and most preferably about 3.3:1.

In order to obtain a desired flavor profile of 4 oz. of refined liquid 6, the contact time with the wooden particles is typically at least 30 seconds and no more than about 120 seconds; preferably at least about 45 seconds and no more than about 90 seconds; and most preferably about 60 seconds. A contact time typically greater than about 120 seconds results in a dark and strong refined liquid 6. A contact time typically less than about 30 seconds results refined liquid 6 with negligible change in the flavor profile.

The maceration pod 30 is intended for a single use of dosed liquid 4. After the dosed liquid 4 is macerated through the maceration pod 30, the ability of the particles 36 to influence the flavor profile of a subsequent dosage of dosed liquid 4 is reduced.

The preferred volume of particles 36 within the maceration pod 30 depends upon the volume of the dosed liquid 4 to be dynamically macerated. In an embodiment of the disclosed subject matter, and for a volume of dosed liquid 4 of about 4 oz., the volume of particles 36 is typically at least about 5 teaspoons and no more than about 8 teaspoons; preferable at least about 6 teaspoons and no more than about 7 teaspoons; and most preferably about 6.5 teaspoons. A volume of particle 36 more than about 8 teaspoons results in a refined liquid 6 having a strong flavor profile. A volume of particles 36 less than about 5 teaspoons results in a refined liquid 6 with a negligible change in its flavor profile.

In a preferred embodiment of the disclosed subject matter, for a 4 oz. volume of dosed liquid 4, the particles 36 may comprise 5 teaspoons medium toasted wooden particles and 1.5 teaspoons heavy toasted wooden particles. The resulting flavor profile of the refined liquid 6 comprises taste characteristics of a barrel aged whiskey about 1 to 4 years older than the flavor profile of the dosed liquid 4.

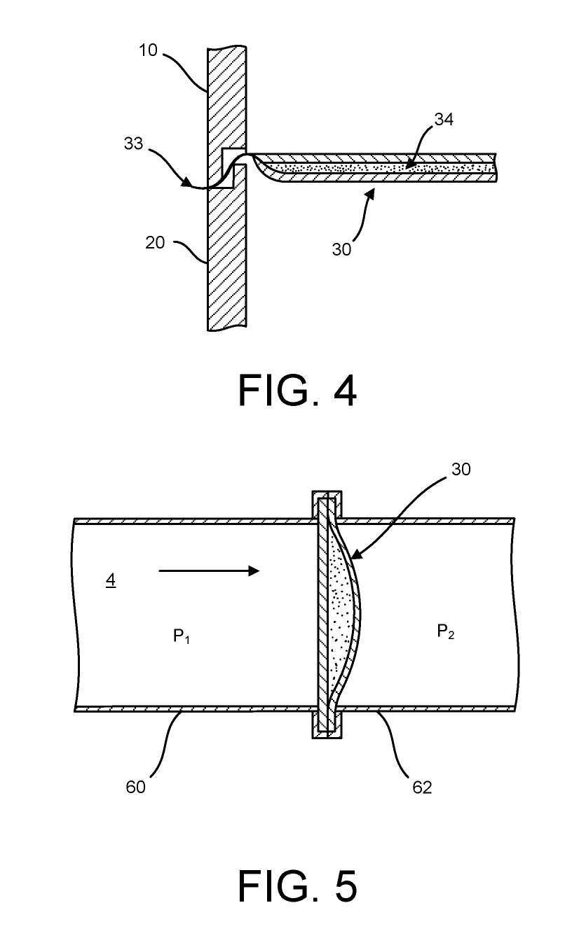

Referring to FIG. 4, in some embodiments of the disclosed subject matter, the peripheral edge 33 is connected between the reservoir 10 and the collector 20. A method of connecting the peripheral edge 33 between the reservoir 10 and collector 20 includes; positioning the peripheral edge 33 over the center of the collector 20, and frictionally fitting the reservoir 10 onto the collector 20; whereby the peripheral edge 33 conforms between the reservoir 10 and collector 20. Once connected between the reservoir 10 and collector 20 the peripheral edge 33 extends radially outward from both the reservoir 10 and the collector 20. The cavity 34 is enclosed inside the reservoir 10 and the collector 20. In this configuration, a maceration pod 30 may efficiently be removed by disconnecting the reservoir 10 from the collector 20. Attachment of the maceration pod 30 between the reservoir 10 and collector 20 requires the dosed liquid 4 to pass through the maceration pod 30.

Referring to FIG. 5, in some embodiments of the disclosed subject matter, the dosed liquid 4 is passed through the maceration pod 30 under a pressure above atmospheric pressure. For example, the maceration pod 30 may be connected between a first section 60 having a first pressure of P₁ and a second section 62 having a second pressure of P₂, where P₁ is great than P₂. Provided a head loss Hₗₒₛₛ across the maceration pod 30 is less than P₁, the dosed liquid 4 flows through the maceration pod 30 from the first section 60 to the second section 62. The first and second sections 60,62 may comprise, alone or in combination, piping, tubing, tanks, flasks and/or vessels. Means of connecting the first and second sections 60,62, for example, may comprise the use of pressure couplings, threaded couplings, fitted couplings, or the like.

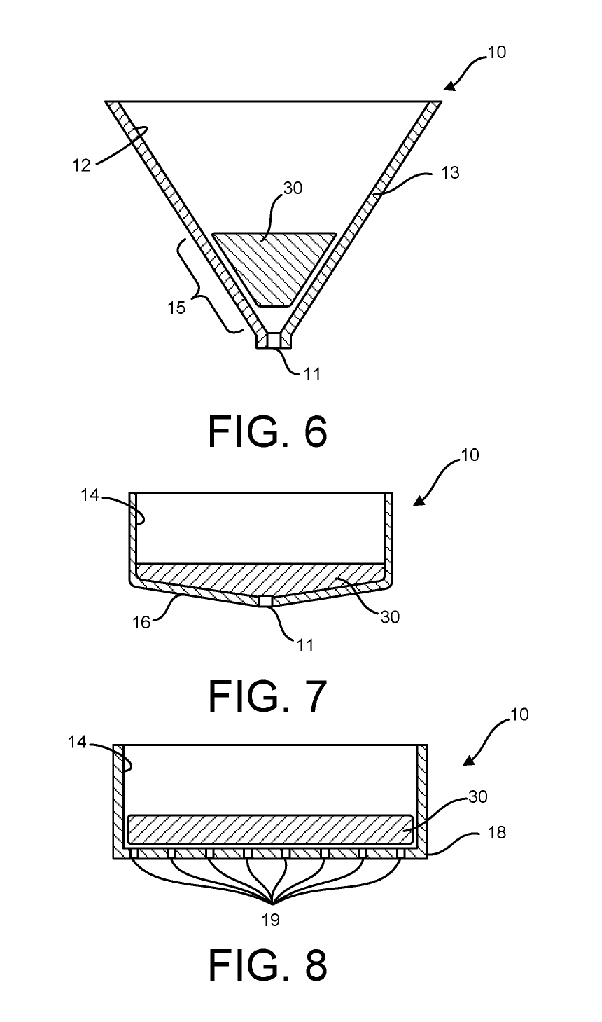

Referring to FIGS. 6-8, in some embodiments of the disclosed subject matter, the maceration pod 30 is configured to snuggly fit along an interior surface 12 or vertical side wall 14 of the reservoir 10. The maceration pod 30 may be snuggly fit onto the interior surface 12 or vertical side wall 14 by firmly inserting the maceration pod 30 into the reservoir 10 towards an outlet 11 of the reservoir 10 (FIGS. 6-7), or a perforated bottom section 18 (FIG. 8); thereby expanding the maceration pod 30 outwardly from a central axis of the reservoir 10.

In FIG. 6, the reservoir 10 comprises a funnel 13 having a lower throat section 15 and an outlet 11. The second layer 31 of the maceration pod 30 may be pre-configured to generally match the dimensions of the lower throat section 15 in order snuggly fit onto the interior surface 12 of the lower throat section 15. Alternatively, the second layer 31 of the maceration pod 30 may be configured to deform upon insertion into the lower throat section 15 in order to snuggly fit onto the interior surface 12 of the lower throat section 15. The maceration pod 30 may be pre-configured in a general shape of an inverted conical frustum or an inverted cone to encourage surface contact between the second layer 31 and the interior surface 12.

Referring to FIG. 7, in some embodiments of the disclosed subject matter, the reservoir 10 comprises a vertical side wall 14 connected to a bottom section 16; the bottom section 16 sloped downwardly to an outlet 11. In some embodiments, the vertical side wall 14 is cylindrically shaped. The maceration pod 30 may be pre-configured to generally match the dimensions of the side wall 14 and/or bottom section 16 in order to snuggly fit into the reservoir 10. Alternatively, the maceration pod 30 may be configured to deform upon insertion into the reservoir 10 in order to snuggly fit along the side wall 14 and/or bottom section 16.

Referring to FIG. 8, in some embodiments of the disclosed subject matter, the reservoir 10 comprises a vertical side wall 14 connected to a perforated bottom section 18. The maceration pod 30 may be pre-configured to generally match the dimensions of the side wall 14 and/or perforated bottom section 18 in order to snuggly fit into the reservoir 10. Alternatively, the maceration pod 30 may be configured to deform upon insertion into the reservoir 10 in order to snuggly fit along the side wall 14 and/or perforated bottom section 18. The maceration pod 30 may comprise a general shape of cylinder when inserted into the reservoir 10. A plurality of perforations 19 in the perforated bottom section 18 are sized to encourage rapid maceration of liquid through the maceration pod 30. The plurality of perforations 19 may comprise slits, holes, punches or apertures that allow flow of refined liquid 6 through the perforated bottom section 18.

It is appreciated that the reservoir 10 and the collector 20 may be combined into a single structure, such as a funnel. Additionally, it is appreciated that the maceration pod 30 may be pre-configured, or capable of deformation, in order to snuggly fit into the reservoir 10 or collector 20 so the dosed liquid 4 does not generally bypass the maceration pod 30.

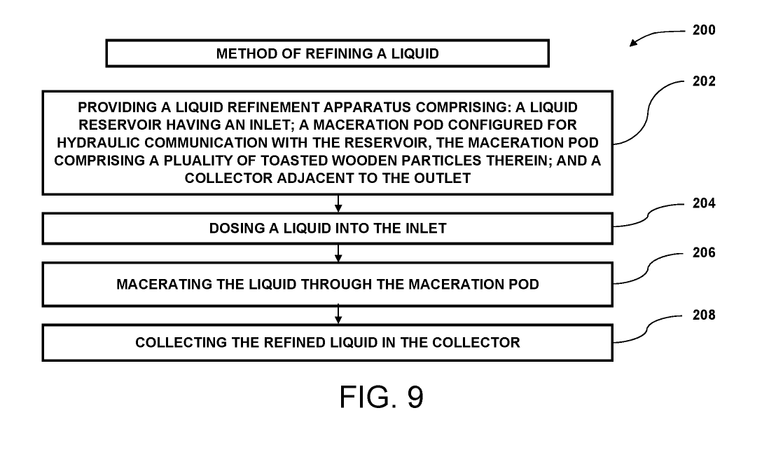

Referring to FIG. 9, in some embodiments of the disclosed subject matter, a method 200 of refining a liquid comprises the steps of: providing a liquid refinement apparatus comprising: a liquid reservoir having an inlet; a maceration pod configured for hydraulic communication with the reservoir, the maceration pod comprising a plurality of wooden particles therein; and a collector adjacent to the outlet (step 202); dosing a liquid into the inlet (step 204); macerating the liquid through the maceration pod (step 206); and collecting the refined liquid in the collector (step 208).

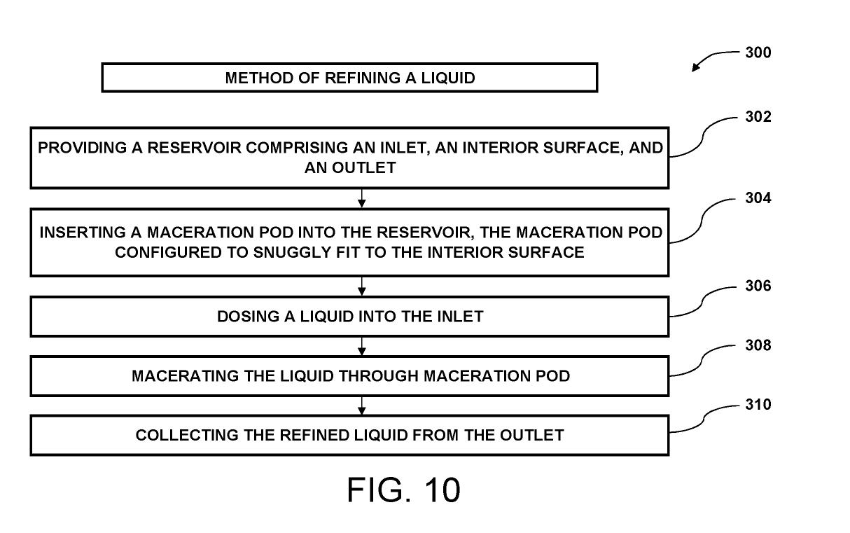

Referring to FIG. 10, in some embodiments of the disclosed subject matter, a method 300 of refining a liquid comprises the steps of: providing a reservoir comprising an inlet, an interior surface, and an outlet (step 302); inserting a maceration pod into the reservoir, the maceration pod configured to snuggly fit to the interior surface (step 304); dosing a liquid into the inlet (step 306); macerating the liquid through maceration pod (step 308); and collecting the refined liquid from the outlet (step 310).

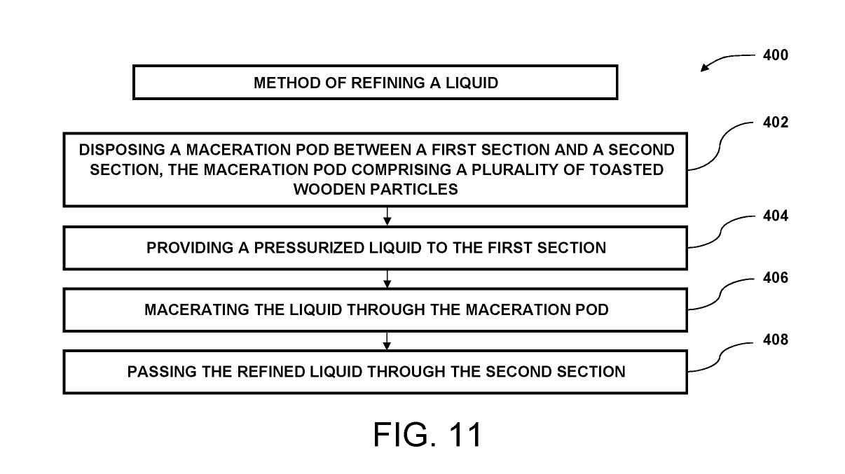

Referring to FIG. 11, in some embodiments of the disclosed subject matter, a method 400 of refining a liquid comprises the steps of: disposing a maceration pod between a first section and a second section, the maceration pod comprising a plurality of toasted wooden particles (step 402); providing a pressurized liquid to the first section (step 404); macerating the liquid through the maceration pod (step 406); and passing the refined liquid through the second section (step 408).

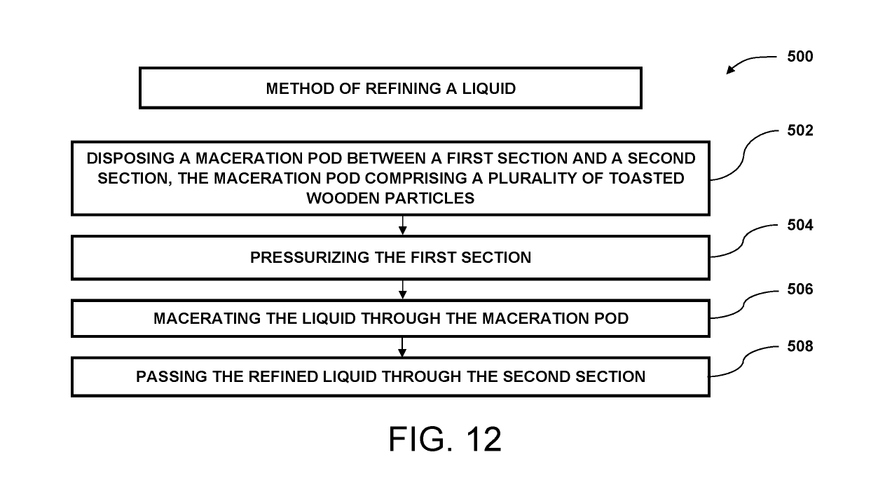

Referring the FIG. 12, in some embodiments of the disclosed subject matter, a method 500 of refining a liquid comprises the steps of: disposing a maceration pod between a first section and a second section, the maceration pod comprising a plurality of toasted wooden particles (step 502); pressurizing the first section (step 504); macerating the liquid through the maceration pod (step 506); and passing the refined liquid through the second section (step 508).

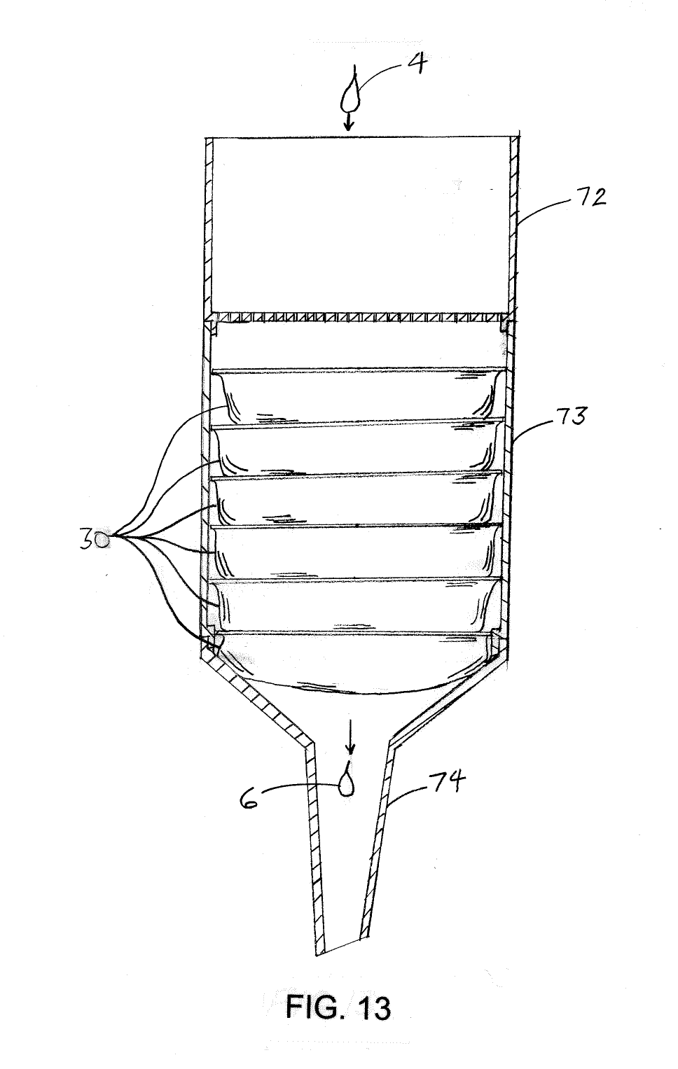

In some embodiments, and referring to FIG. 13, an extension portion 73 is hydraulically connected between the upper portion 72 and the lower portion 74; whereby a plurality of maceration pods 30 are secured within the space formed between the upper portion 72, the extension portion 73, and the lower portion 74. In some embodiments, the extension portion 73 is generally cylindrical in shape. The extension portion may be configured to accommodate up to at least six maceration pods 30, wherein the maceration pods 30 are horizontally stacked upon each other. Through the use of the extension portion 73 and a plurality of maceration pods 30, the apparatus 1 may macerate a volume of 750 ml. of dosed liquid 4 by slowly pouring the dosed liquid 4 into the upper portion 72. In some embodiments, less than six maceration pods 30 may be secured within the extension portion 73 depending on the desired flavor profile of the refined liquid 6.

It is to be understood that while certain aspects of the disclosed subject matter have been shown and described, the disclosed subject matter is not limited thereto and encompasses various other embodiments and aspects.

Insofar as the description above and the accompanying drawings disclose any additional subject matter that is not within the scope of the single claim below, the inventions are not dedicated to the public and the right to file one or more applications to claim such additional inventions is reserved.

Having described the disclosed subject matter, what is claimed as new and desired to be secured by Letters Patent is:

1. A liquid refinement apparatus, comprising:
a liquid reservoir;
a collector; and
a maceration pod configured for hydraulic communication with the reservoir and the collector, the maceration pod comprising a plurality of toasted wooden particles.

2. The liquid refinement apparatus of claim 1, further comprising an extension portion connected between the reservoir and the collector.

3. The liquid refinement apparatus of claim 1, wherein the plurality of toasted wooden particles comprise a particle size greater than about 200 microns.

4. The liquid refinement apparatus of claim 1, wherein the plurality of toasted wooden particles comprise a particle size less than about 1180 microns.

5. The liquid refinement apparatus of claim 1, wherein the plurality of toasted wooden particles comprise a particle size greater than about 200 microns and less than about 1180 microns.

6. The liquid refinement apparatus of claim 1, wherein less than about 70% of the plurality of toasted wooden particles comprise a particle size less than about 600 microns.

7. The liquid refinement apparatus of claim 1, wherein less than about 70% of the plurality of toasted wooden particles comprise a particle size greater than about 600 microns.

8. The liquid refinement apparatus of claim 1, wherein the plurality of toasted wooden particles selected from the group consisting of oak, maple, hickory, cherry, birch and apple wood.

9. The liquid refinement apparatus of claim 1, the wherein the plurality of toasted wooden particles comprise a volume greater than about 5 teaspoons and less than about 8 teaspoons.

10. The liquid refinement apparatus of claim 1, wherein the plurality of toasted wooden particles comprise a volume about 5 teaspoons of medium toasted wood and about 1.5 teaspoons of heavy toasted wood.

11. The liquid refinement apparatus of claim 1, wherein the plurality of toasted wooden particles comprise a volumetric ratio of medium toasted wood particles to heavy toasted wood particles of between about 1:1 and about 5:1.

12. The liquid refinement apparatus of claim 1, wherein the plurality of toasted wooden particles comprise a volumetric ratio of medium toasted wood particles to heavy toasted wood particles of about 3.3:1.

13. The liquid refinement apparatus of claim 1, wherein the maceration pod comprises:
a first layer having a peripheral edge; and
a second layer connected to the first layer along the peripheral edge; wherein a cavity is formed between the first layer and the second layer, the plurality of toasted wooden particles disposed within the cavity.

14. The liquid refinement apparatus of claim 13, wherein the peripheral edge is connected between the liquid reservoir and the collector.

15. A liquid refinement apparatus, comprising:
a liquid reservoir having an outlet; and
a maceration pod configured to snuggly fit along an interior surface of the reservoir, the maceration pod comprising a plurality of toasted wooden particles therein.

16. The liquid refinement apparatus of claim 15, wherein the interior surface configured to slope towards the outlet.

17. The liquid refinement apparatus of claim 15, the interior surface comprises:
a vertical side wall; and
a bottom section connected to the side wall, the bottom section configured to slope towards the outlet.

18. The liquid refinement apparatus of claim 15, the interior surface comprises:
a vertical side wall; and
a bottom section connected to the side wall, the bottom section comprising a plurality of perforations.

19. A liquid refinement apparatus, comprising:
a liquid reservoir having an outlet;
a collector coupled to the outlet; and
a maceration pod comprising:
a first layer having a peripheral edge; the peripheral edge connected between the outlet and the collector;
a second layer connected to the first layer along the peripheral edge, wherein a cavity is formed between the first layer and second layer; and
a plurality of toasted wooden particles disposed within the cavity; the plurality of toasted wooden particles comprising:
a particle size greater than about 200 microns and less than about 1180 microns;
a volume greater than 5 teaspoons and less than about 8 teaspoons; and
a volumetric ratio of medium toasted wood particles to heavy toasted wood particles of between about 1:1 and about 5:1.

20. A method of macerating a liquid, comprising the steps of:
providing a liquid refinement apparatus comprising:
a liquid reservoir;
a maceration pod configured for hydraulic communication with the reservoir, the maceration pod comprising a plurality of toasted wooden particles therein; and a collector adjacent to the outlet;
dosing a liquid into reservoir;
macerating the liquid through the maceration pod; and
collecting the refined liquid in the collector.

21. The method of claim 20, wherein the plurality of toasted wooden particles comprise a particle size greater than about 200 microns and less than about 1180 microns.

22. The method of claim 20, further comprising the step of pressurizing the liquid prior to the macerating step.
